(19) United States
(12) Patent Application Publication
(10) Pub. No.: US 2007/0199617 A1
(43) Pub. Date: Aug. 30, 2007

(54) Motorized stationery item

(76) Inventors: King Biu Mak, Kowloon (CN); Chung Ming Mak, Kowloon (CN); Ronald Chung Yin Mak, Kowloon (CN)

Correspondence Address: WILLIAM J. SAPONE;COLEMAN SUDOL SAPONE P.C., 714 COLORADO AVENUE, BRIDGE PORT, CT, 06605, US

(21) Appl. No.: 11/322,928

(22) Filed: Dec. 30, 2005

(51) Int. Cl. B43L 23/00

(52) U.S. Cl. 144/28.72

(57) ABSTRACT

A stationery item, e.g. a letter opener or a pencil sharpener, with a motor actuatable to move a cutting member to perform a task, e.g. to cut open a letter or to sharpen a pencil, and in addition to movement of the cutting member, the stationery item also generates a further mechanical, audio, or visual output.

This invention relates to a motorized stationery item, and in particular such a stationery item which, in addition to performing its own intended function, also provides an additional output.

### BACKGROUND OF THE INVENTION

In the existing field of motorized stationery items, most of the attention has been directed to improving the performance of the stationery items. Although some effort has been made to improve the outlook of such items, such design only relates to the outward appearance of the stationery items, without significantly enhancing the interest brought about by using such stationery items.

It is thus an object of the present invention to provide a new stationery item in which the aforesaid shortcomings are mitigated, or at least to provide a useful alternative to the public.

### SUMMARY OF THE INVENTION

According to the present invention, there is provided a stationery item with at least one motor actuatable to move at least one operating member to perform a task, wherein in addition to movement of said operating part, said stationery item is adapted to generate at least a further output.

### BRIEF DESCRIPTION OF THE DRAWINGS

Preferred embodiments of the present invention will now be described, by way of example only, with reference to the accompanying drawings, in which:

FIG. 1 shows a front view of a motorized letter opener according to a first preferred embodiment of the present invention;

FIG. 2 is a top view of the letter opener of FIG. 1;

FIG. 3 is a side view of the letter opener of FIG. 1;

FIG. 4 is a sectional view taken along the line A-A of FIG. 2;

FIG. 5 is a sectional view taken along the line B-B of FIG. 3;

FIG. 6 is an enlarged side view of the letter opener showing the structure for operating movement of the upper jaw and foot of the letter opener;

FIG. 7 is a side view of a motorized pencil sharpener according to a second preferred embodiment of the present invention;

FIG. 8 is a front view of the pencil sharpener of FIG. 7;

FIG. 9 is a sectional view taken along the line C-C of FIG. 7;

FIG. 10 is a sectional view taken along the line D-D of FIG. 9;

FIG. 11 is a schematic diagram showing the state of the electric circuit of the pencil sharpener of FIG. 7 prior to insertion of a pencil;

FIG. 12 is a schematic diagram showing the state of the electric circuit of the pencil sharpener of FIG. 7 after insertion of a pencil;

FIG. 13 is a top view of a motorized letter opener according to a third preferred embodiment of the present invention;

FIG. 14 is a front view of the letter opener of FIG. 13;

FIG. 15 is a bottom view of the letter opener of FIG. 13;

FIG. 16 is a side view of the letter opener of FIG. 13;

FIG. 17 is a rear view of the letter opener of FIG. 13;

FIG. 18 is an enlarged partly exposed top view of the letter opener of FIG. 13;

FIG. 19 is a sectional view taken along the line E-E of FIG. 18;

FIG. 20 is a first exemplary circuit block diagram of the letter opener of FIG. 13;

FIG. 21 is a second exemplary circuit block diagram of the letter opener of FIG. 13; and

FIG. 22 is a block diagram of a recording/playback integrated circuit which may be used in the circuit of FIG. 21.

### DETAILED DESCRIPTION OF THE PREFERRED EMBODIMENTS

FIGS. 1 to 3 show a motorized letter opener according to a first preferred embodiment of the present invention, generally designated as 100. The letter opener 100 is in the general shape of a penguin, with a head 102, two wings 104 attached to a body 106, an upper jaw 108, a lower jaw 110 and two feet 112, 114.

When a letter (not shown) is fed along a gap 109 between the upper jaw 108 and the lower jaw 110 of the letter opener 100, the letter opener 100 will be actuated to cut open the letter, while the upper jaw 110 will swivel up and down, the two wings 104 will swivel up and down in flapping action, and one of the feet, namely the foot 112, will also swivel up and down in a tapping movement.

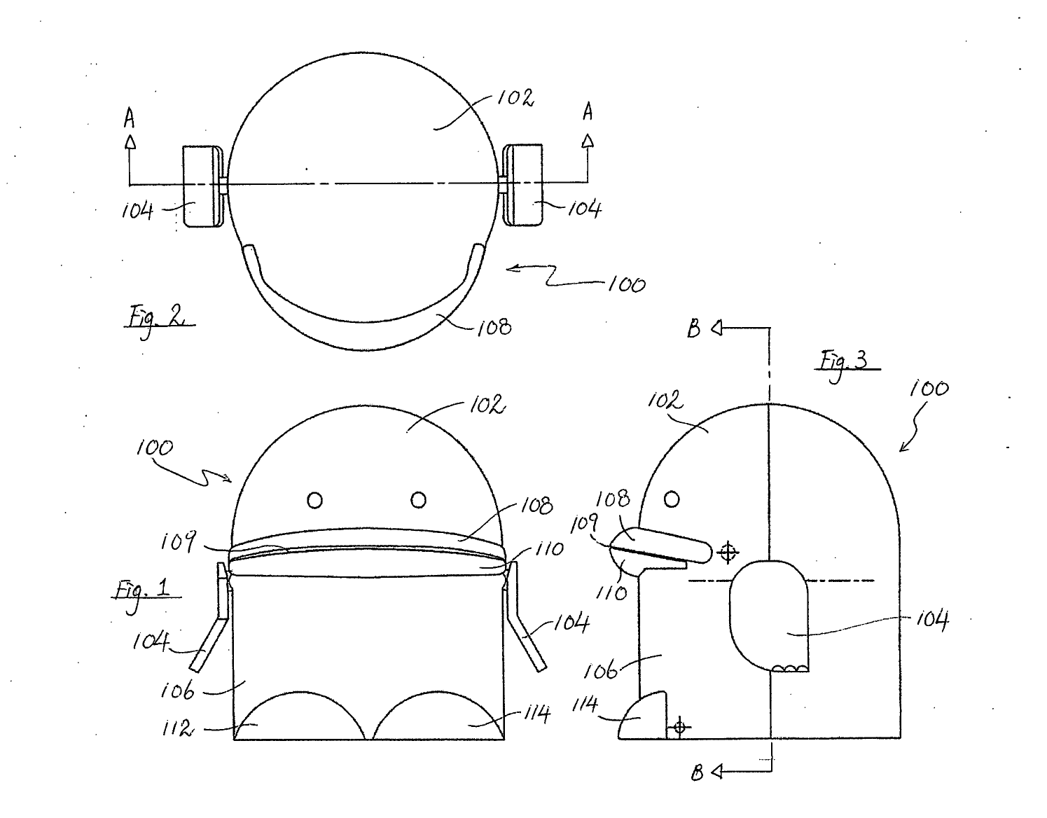

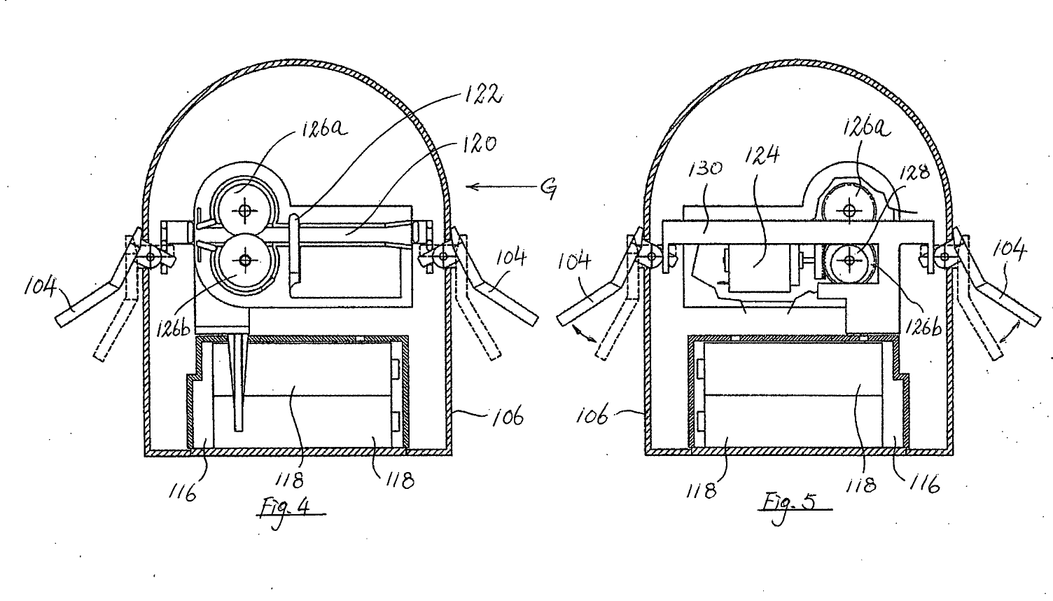

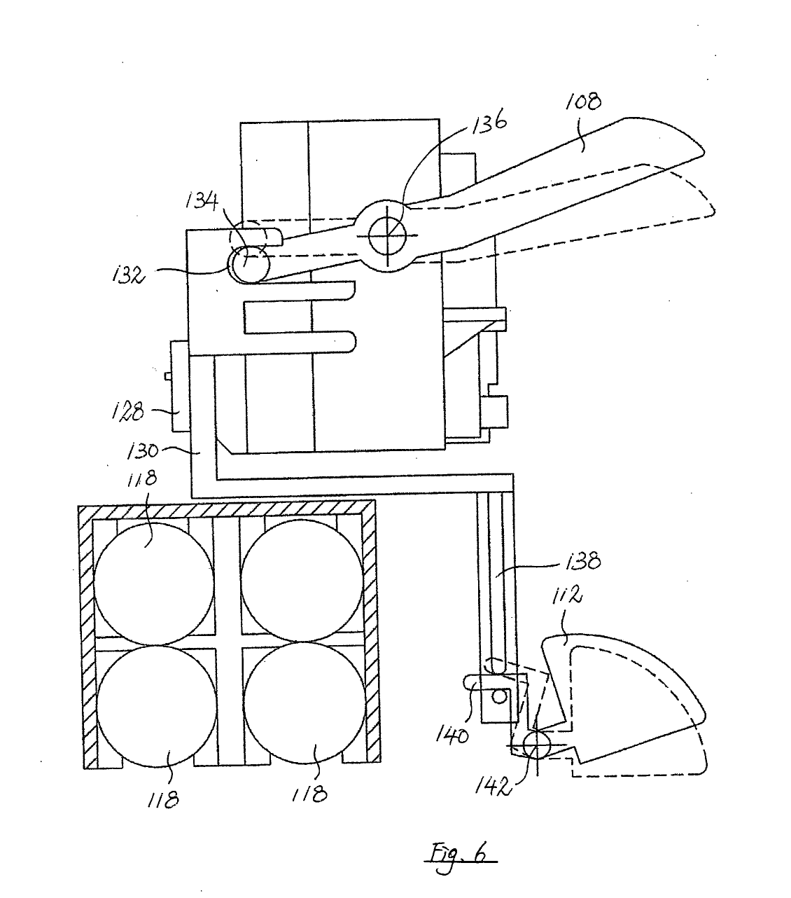

As shown in FIGS. 4 and 5, a lower part of the body 106 has a compartment 116 for housing a number of dry batteries 118 for powering the letter opener 100. When a letter is caused to move along the gap 109 between the upper jaw 108 and the lower jaw 110 in the direction of the arrow G in FIG. 4, it is received within a recess 120 in the letter opener 100. When the letter so moves along the recess 120, it will move a mechanical switch 122 to actuate a motor 124 to cause two circular cutting blades 126a, 126b to rotate to cut open the letter passing by the two cutting blades 126a, 126b.

A rear side of the lower cutting blade 126b is fixed with a cam 128, whose operating side surface bearing on a link member 130. Thus, during rotation of the lower cutting blade 126b, the link member 130 will move up and down vertically. As shown in FIG. 5, each of the wings 104 has a pivot point fixed relative to the body 106, and a distal end engaged with the link member 130. Thus, up and down movement of the link member 130 will cause the wings 104 to swivel up and down about the respective pivot point between the positions shown in solid line and dotted line respectively.

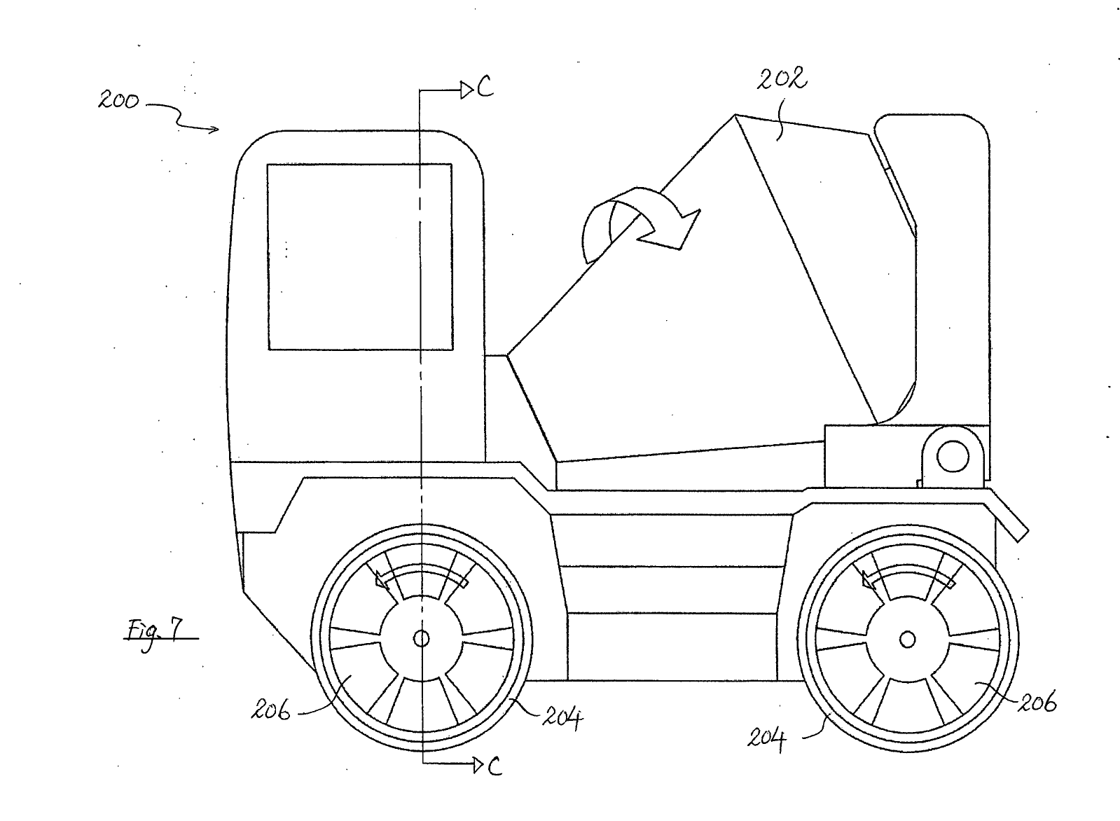

As shown in FIG. 6, the link member 130 has an upper recess 132 within which is received an inward end 134 of the upper jaw 108. The upper jaw 108 is fixed at 136 for pivotal movement. A lower end of the link member 130 is in the form of a downwardly pointing pin 138 acting on an inwardly extending pin 140 of the foot 112 which pivots about the point 142. Thus, during operation of the motor 124, the lower cutting blade 126b will rotate, causing the cam 128 to move the link member 130 up and down, which will bring about simultaneous up and down swiveling movement of the upper jaw 108 and the foot 112. It can be seen that the wings 104 are swivellable about an axis which is perpendicular to the axes about which the upper jaw 108 and the foot 112 swivel. In addition, the axes about which the wings 104, the upper jaw 108 and the foot 112 swivel are perpendicular to the vertical longitudinal axis of the letter opener 100. As such, in addition to performing the intended letter opening function, the letter opener 100 also generates additional mechanical outputs in the form of swivelling movements of the wings 104, the upper jaw 108 and the foot 112, which are perceivable by a user.

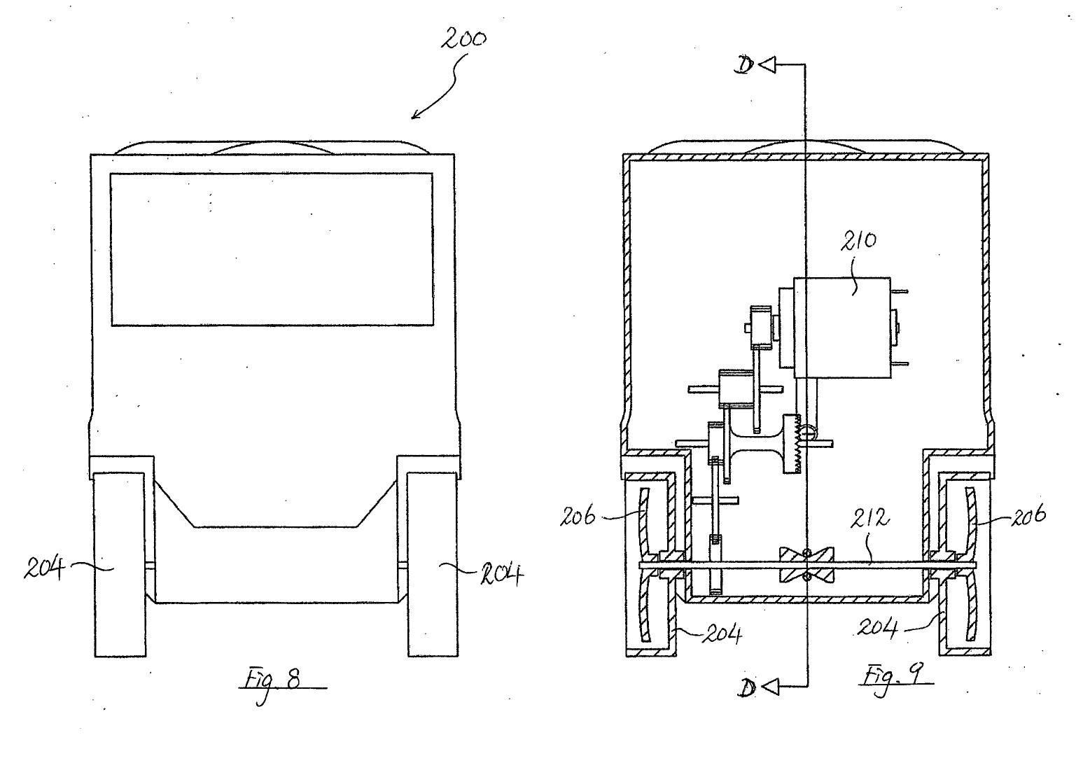

FIGS. 7 and 8 show a motorized sharpener for a writing instrument, e.g. a pencil sharpener, according to a second preferred embodiment of the present invention, generally designated as 200. The pencil sharpener 200 is in the general shape of a concrete truck, with a rotatable concrete container 202 and a number of fixed wheels 204, each with an associated rim 206 which is rotatable relative to the respective fixed wheel 204.

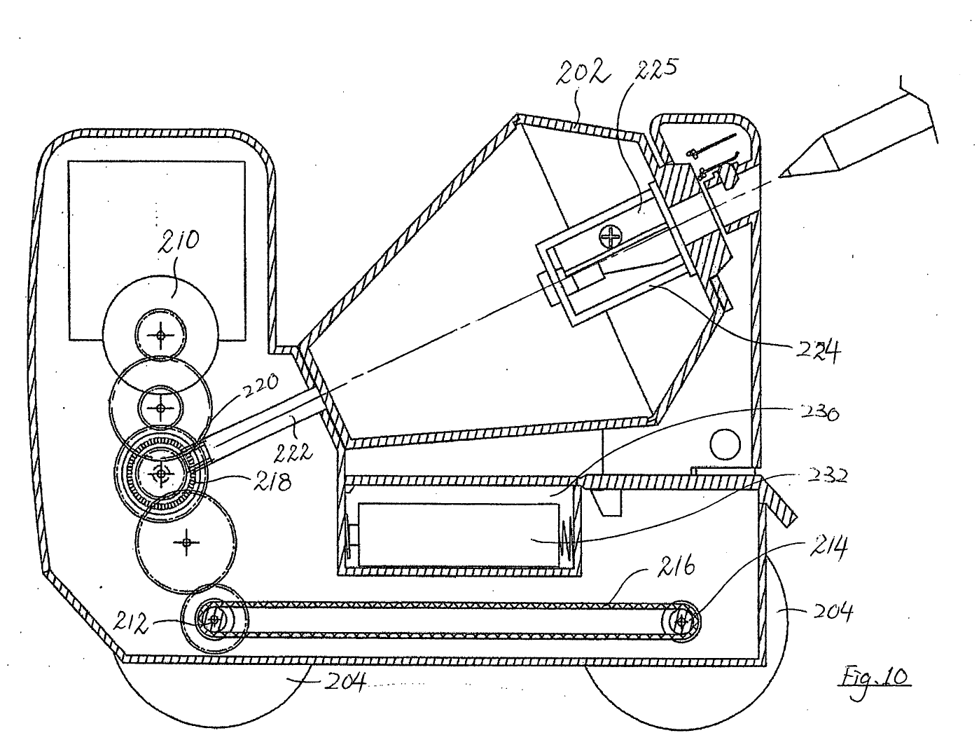

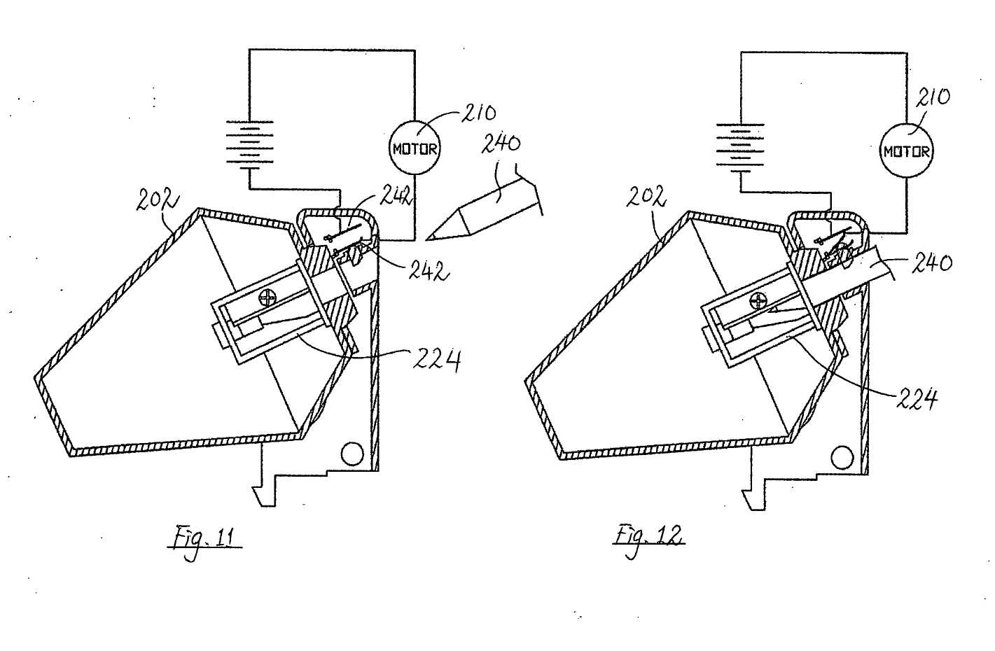

As shown in FIGS. 9 and 10, when a motor 210 of the pencil sharpener 200 is actuated, such drives, via a set of gear arrangement, a front axle 212 into rotational movement. The rims 206 are fixed to the longitudinal ends of the front axle 212 for simultaneous rotational movement. The front axle 212 is also connected with a rear axle 214 for simultaneous rotational movement via an endless chain 216. Thus, rotational movement of the front axle 212 will bring about simultaneous rotational movement of the rear axle 214, and thus the two rims 206 attached thereto. Within the pencil sharpener 200 is a compartment 230 for housing one or more batteries 232 for powering the motor 210.

In addition, as shown more clearly in FIG. 10, a gear 218 of the gear arrangement is in mesh with a toothed part 220 of a spindle 222 fixedly engaged with the concrete container 202 in which is provided a pencil sharpener 224 with a cutting blade 225. Thus, rotation of the gear 218 will set the spindle 222 into rotational movement about its own longitudinal axis, which will also bring about corresponding simultaneous rotation of the concrete container 202, and thus the pencil sharpener 224 carried by it.

As shown in FIG. 11, prior to insertion of a pencil 240, two electrically conductive contact plates 242 of an electric circuit of the pencil sharpener 200 are out of contact with each other, such that the electric circuit is open. Once the pencil 240 is inserted into the rear end of the concrete container 202, it causes the contact plates 242 to come into contact with each other to close the circuit, and thus to actuate the motor 210, whereupon the axles 212, 214 and the associated rims 206, as well as the concrete container 202 and the pencil sharpener 224 carried by it, will be set into rotational movement about their respective axis of rotation. Thus, in addition to performing the pencil sharpening function, the pencil sharpener 200 also generates additional mechanical outputs in the form of rotational movements of the concrete container 202 and the rims 206.

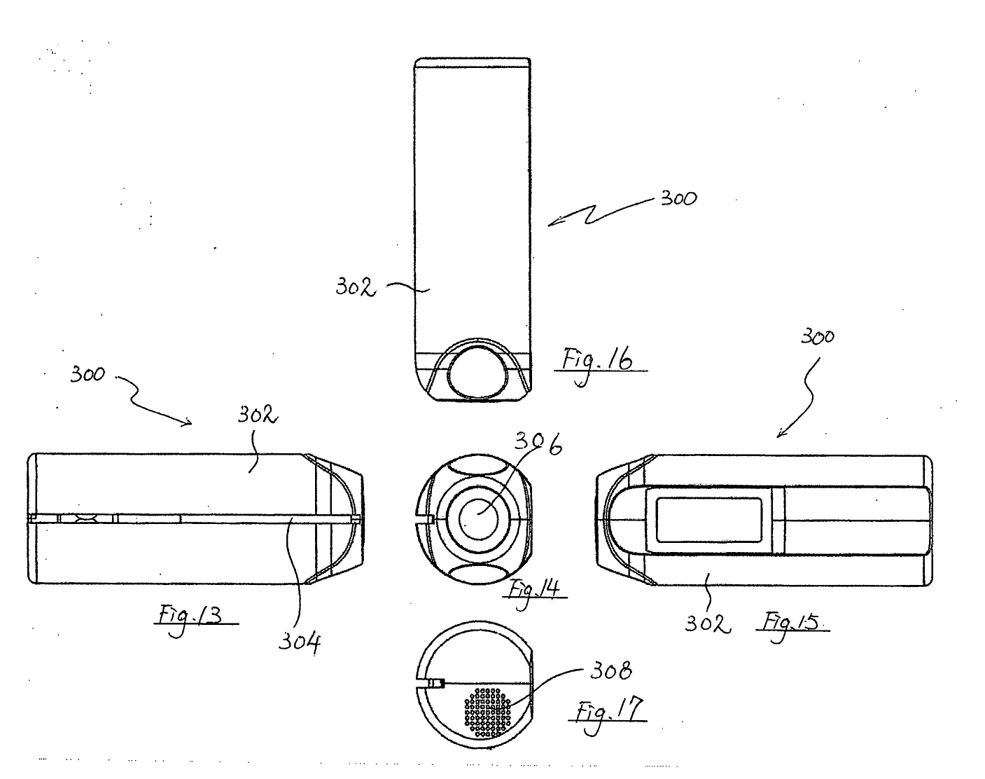

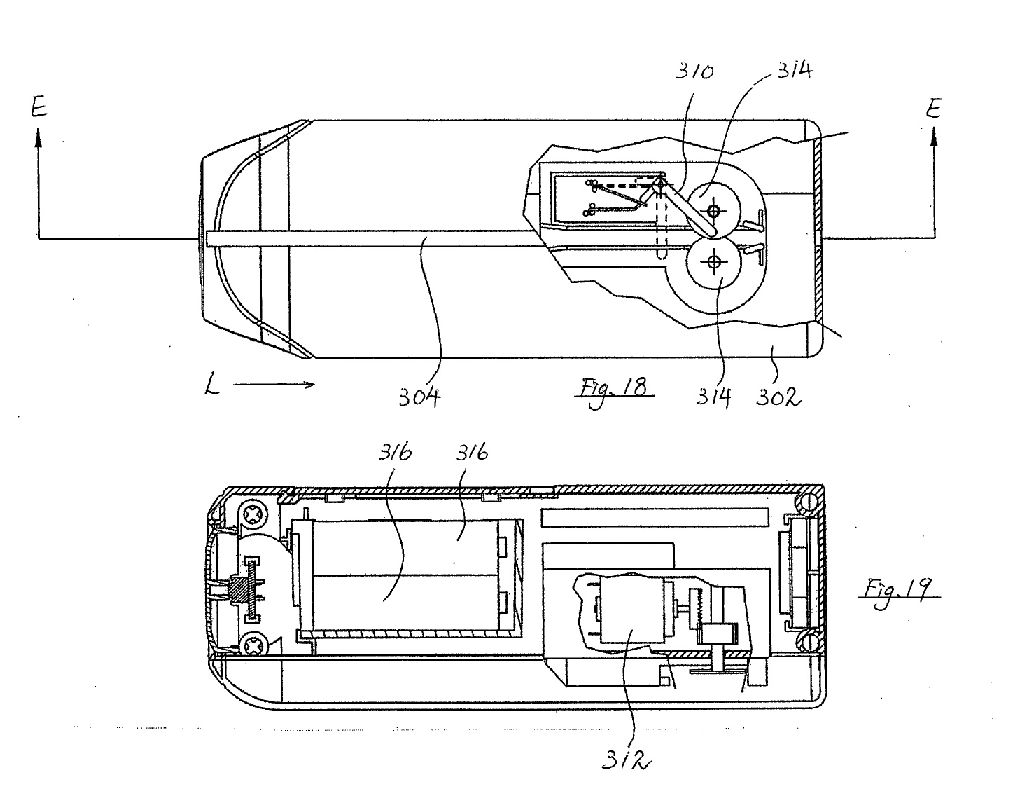

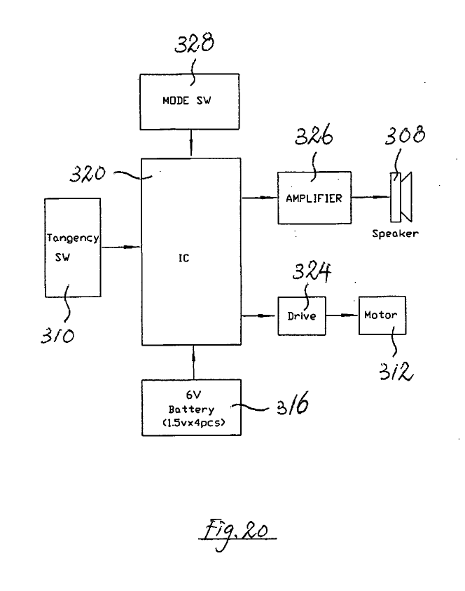

FIGS. 13 to 17 show various views of a letter opener according to a third preferred embodiment of the present invention, generally designated as 300. The letter opener 300 includes a generally cylindrical body 302 with a slot 304 along which a letter (not shown) to be cut open may be fed. A front end of the body 302 is provided with a button 306, and a rear end of the body 302 is provided with a speaker 308, the functions of which will be discussed below.

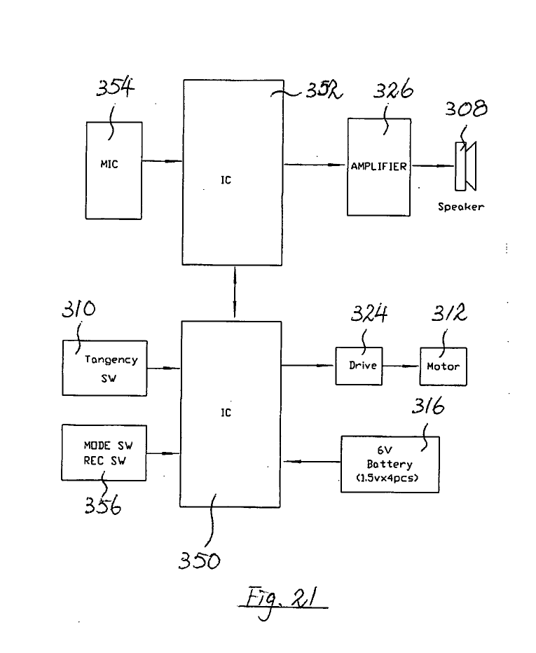

As shown in FIGS. 18 and 19, when a letter (not shown) is fed along the slot 304 in the direction of the arrow L, a switch 310 will be moved from the position shown in dotted line to the position shown in solid line, to close an electric circuit in the letter opener 300. A motor 312 will then be activated to cause two blade cutters 314 to rotate to cut open the passing letter. As shown in FIG. 19, batteries 316 are provided for powering the operation of the letter opener 300.

Two versions of the letter opener 300 may be provided. A circuit block diagram of a first version of the letter opener 300 is shown in FIG. 20. An integrated circuit (IC) 320 is provided for generally controlling and monitoring the operation of the letter opener 300, and storing and reproduction of audio signals. A suitable IC for such purposes may be a controller-based speech synthesizer IC traded by Elan Microelectronics Corp. of Taiwan under the Trade Mark EASY SOUND®—eST Series.

eST Series is a series of 3 to 340 seconds single chip high quality voice synthesizer IC containing one 4-bit input port; three 4-bit I/O ports and a controller. There is a programmable read-only-memory (ROM) to which audio data may be stored for subsequent output.

Thus, and as shown in FIG. 20, when the switch 310 (referred to as “Tangency Switch” in FIG. 20) is activated, the IC 320 will also be activated to operate, via a driver circuit 324, the motor 312 to cause the two blade cutters 314 to rotate. Simultaneously, or after a predetermined time delay set by the manufacturer, the IC 320 will also output the pre-stored audio data to be amplified by an amplifying circuit 326 for subsequent output by the speaker 308. Such pre-stored audio data may be a voice message, such as “Thank You”, or a song. A mode switch 328 associated with the button 306 is also provided for changing the mode in which the letter opener 300 may operate.

A circuit block diagram of a second version of the letter opener 300 is shown in FIG. 21. A major difference between the circuit arrangement of FIG. 20 and that shown in FIG. 21 is that, in the circuit arrangement of FIG. 21, a user may record his/her own audio signals into the letter opener for subsequent output. To allow for such a function, two ICs are provided.

In particular, an IC 350 similar to the IC 320 in FIG. 20 is provided for receiving signals from the switch 310 for subsequent operation of the motor 312 via the driver circuit 324. A second IC 352 is connected with the IC 350 for controlling the input, recording and reproduction of audio signals. As shown in FIG. 21, the IC 352 is connected with a microphone 354 from which audio signals may be received for storage in the IC 352. Upon activation of the recording function by operating a Mode/Record switch 356 which is associated with the button 306, the IC 350 will issue instructions to the IC 352 to receive audio signals from the microphone 354 for storage. Upon activation of the switch 310, the IC 350 will issue instructions to the IC 352 to output the stored audio signals to be amplified by an amplifier 326 for subsequent output by a speaker 308. This thus allows the user to input his/her own message, music or the like into the letter opener 300 to be play-backed upon, or after a pre-set time delay of, operation of the motor 312.

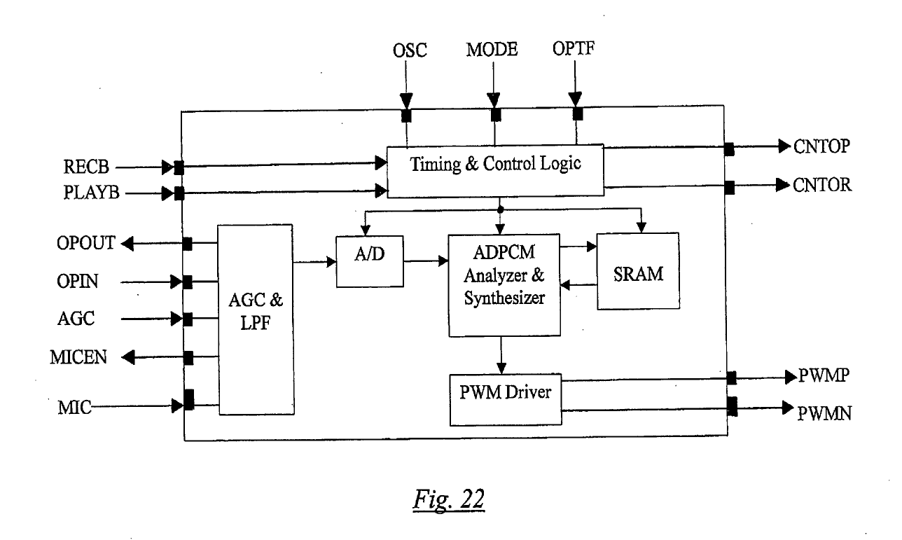

A suitable IC for use as the IC 352 may be a 6-second voice recording/playback IC traded by Winlead Integrated Circuit Design Corp., of Taiwan, under Serial No. E18075, a block diagram of which is shown in FIG. 22.

It should be understood that the above only illustrates examples whereby the present invention may be carried out, and that various modifications and/or alterations may be made thereto without departing from the spirit of the invention. For example, although in the embodiments described above, the additional output generated is a mechanical output or an audio output, it is envisaged that visual output may also be generated. For example, for the letter opener 300, a liquid crystal display (LCD) may be connected with the IC 320 or IC 352 such that upon operation of the motor 312, or after a pre-set time delay, the IC 320 or 352 may issue instructions to the LCD to show a message or cartoon character. Similarly, a number of light-emitting diodes (LEDs) may also be provided so that upon operation of the motor, or after a pre-determined period of time, the LEDs are lighted up or to flash, to form a stationary or changing visual pattern.

In addition, although in each of the embodiments described above, only one type of additional output is issued in addition to the operation of the operating part of the stationery item, it is of course possible to so arrange that the stationery item generates more than one type of additional output. For example, using the letter opener 100 as an example, in addition to rotational movement of the cutting blades 126a, 126b, and swivelling movement of the upper jaw 108, wings 104 and the foot 112, it is possible to also provide an IC, an appropriate amplifying circuit and a speaker to also playback voice message or music pre-stored in the IC. To further enhance the interest of using the letter opener 100, each of the eyes of the penguin letter opener 100 may also be provided with an LED which flashes during operation of the motor 124.

It should thus be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

1. A stationery item with at least one motor actuatable to move at least one operating member to perform a task, wherein in addition to movement of said operating part, said stationery item is adapted to generate at least a further output.

2. A stationery item according to claim 1 wherein said stationery item comprises a letter opener or a sharpener for a writing instrument.

3. A stationery item according to claim 1 wherein said further output is a mechanical output, an audio output, or a visual output.

4. A stationery item according to claim 1 wherein said operating part is at least one cutting member.

5. A stationery item according to claim 1 further including at least one movable part which is movable by said motor to swivel about an axis.

6. A stationery item according to claim 5 wherein said at least one movable part is moved by said motor during movement of said at least one operating member.

7. A stationery item according to claim 6 wherein said at least one movable part is moved by said motor via a cam member.

8. A stationery item according to claim 5 wherein said axis of swivelling is generally perpendicular to the longitudinal axis of said stationery item.

9. A stationery item according to claim 8 wherein said movable part is in the form of a wing member of a bird.

10. A stationery item according to claim 8 wherein said movable part is in the form of a foot of an animal.

11. A stationery item according to claim 5 further including at least two movable parts which are movable by said motor to each swivel about a respective axis, wherein said at least two axes are substantially perpendicular to each other.

12. A stationery item according to claim 1 further including at least one movable part which is movable by said motor to rotate about an axis.

13. A stationery item according to claim 12 wherein said at least one movable part is in the form of a rim of a wheel.

14. A stationery item according to claim 13 further including a plurality of movable parts, each in the form of a rim of a wheel, which are movable by said motor to each rotate about a respective axis.

15. A stationery item according to claim 1 further including at least an integrated circuit adapted to record audio signals.

16. A stationery item according to claim 15 wherein said integrated circuit is adapted to output said audio signals via a speaker member in response to operation of said stationery item.

17. A stationery item according to claim 15 further including at least a microphone adapted to allow input of audio signals into said integrated circuit.

18. A stationery item according to claim 17 including at least a first and a second integrated circuits, wherein said first integrated circuit is adapted to control the operation of said stationery item and said second integrated circuit is adapted to control the recording and reproduction of said audio signals.
